(19) United States
(12) Patent Application Publication
(10) Pub. No.: US 2024/0062945 A1
(43) Pub. Date: Feb. 22, 2024

(54) WIRELESS TRANSMISSION MODULE

(71) Applicant: TDK TAIWAN CORP., Taoyuan City (TW)

(72) Inventors: Kuang-Lun LEE, Taoyuan City (TW); Feng-Lung CHIEN, Taoyuan City (CN); Mao-Chun CHEN, Taoyuan City (TW); Chien-Hung LIN, Taoyuan City (TW); Chia Ho CHANG, Taoyuan City (TW); Wen-Pin CHANG, Taoyuan City (TW)

(21) Appl. No.: 18/165,682

(22) Filed: Feb. 7, 2023

(30) Foreign Application Priority Data
Aug. 19, 2022 (CN) 202211003195.6

(51) Int. Cl. H01F 27/28; H01F 27/06; H02J 50/10; H04B 5/00

(52) U.S. Cl. CPC H01F 27/2804; H01F 27/06; H02J 50/10; H04B 5/0081; H04B 5/0037; H01F 2027/2809

(57) ABSTRACT

A wireless transmission module for transmitting energy or signals includes a coil assembly and an induction substrate. The coil assembly has a winding axis, and the induction substrate corresponds to the coil assembly. The induction substrate has a first surface facing the coil assembly.

### CROSS REFERENCE TO RELATED APPLICATIONS

This application claims the benefit of China Patent Application No. 202211003195.6, filed on Aug. 19, 2022, the entirety of which is incorporated by reference herein.

### BACKGROUND OF THE DISCLOSURE

### Field of the Disclosure

The present disclosure relates to a wireless transmission module, and more particularly to a wireless transmission module used for wireless communication or wireless charging.

### Description of the Related Art

As technology has progressed, many kinds of electronic devices such as tablet computers and smartphones have begun to include the functionality of wireless charging. A user can place an electronic device on a wireless charging transmitting terminal so that the wireless charging receiving terminal in the electronic device generates current via electromagnetic induction or electromagnetic resonance, thereby charging the battery. Due to the convenience of wireless charging, electronic devices equipped with wireless charging modules have gradually become popular.

In general, wireless charging modules include a magnetically conductive substrate to support a coil. When the coil is provided with electricity to operate in a wireless charging mode or a wireless communication mode, the magnetically conductive substrate can concentrate the magnetic lines of force emitted from the coil for better performance. However, the existing structure of the wireless charging (or communication) module and the existing way of winding the coil do not meet the various requirements for wireless transmission modules, such as better charging performance, better communication performance, and less thickness.

Therefore, how to design a wireless transmission module capable of fulfilling the user's various needs is a topic nowadays that needs to be discussed and solved.

### BRIEF SUMMARY OF THE DISCLOSURE

According to some embodiments of the disclosure, a wireless transmission module includes a coil assembly and an induction substrate. The coil assembly has a winding axis, and the induction substrate corresponds to the coil assembly. The induction substrate has a first surface facing the coil assembly.

According to some embodiments, the induction substrate includes a first block, a second block, a third block, a fourth block, a first gap, a second gap and a third gap. The second block is adjacent to the first block. The third block is adjacent to the second block. The fourth block is adjacent to the third block. The first gap is adjacent to and between the first block and the second block. The second gap is adjacent to and between the second block and the third block. The third gap is adjacent to and between the third block and the fourth block.

According to some embodiments, the second block is located between the first gap and the second gap. The third block is located between the second gap and the third gap. The shortest distance between the first gap and the second gap is less than the shortest distance between the second gap and the third gap.

According to some embodiments, the included angle between the extending direction of the first gap and an extending direction of the second gap is less than 20 degrees. The included angle between the extending direction of the second gap and the extending direction of the third gap is less than 20 degrees.

According to some embodiments, the induction substrate further includes a first boundary, extending along a first axis. The first block, the second block, the third block and the fourth block are sequentially arranged along an inclined axis. The inclined axis is not parallel to the first axis.

According to some embodiments, the length of the first gap is different from the length of the second gap. The length of the first gap is less than the length of the second gap.

According to some embodiments, the length of the second gap is different from the length of the third gap. The length of the second gap is less than the length of the third gap. The included angle between the extending direction of the first gap and the extending direction of the first boundary is greater than 45 degrees.

According to some embodiments, the induction substrate further includes a first boundary, extending along a first axis. The first gap is closer to the first boundary than the second gap. The second gap is closer to the first boundary than the third gap. The included angle between the extending direction of the first gap and the extending direction of the first boundary is less than 20 degrees.

According to some embodiments, the induction substrate further includes a fifth block, a sixth block, a seventh block, an eighth block, a ninth block, a tenth block, a fourth gap, a fifth gap, a sixth gap and a seventh gap. The sixth block is adjacent to the fifth block. The seventh block is adjacent to the sixth block. The ninth block is adjacent to the eighth block. The tenth block is adjacent to the ninth block. The fourth gap is adjacent to and between the fifth block and the sixth block. The fifth gap is adjacent to and between the sixth block and the seventh block. The sixth gap is adjacent to and between the eighth block and the ninth block. The seventh gap is adjacent to and between the ninth block and the tenth block.

According to some embodiments, the sixth block is located between the fourth gap and the fifth gap. The ninth block is located between the sixth gap and the seventh gap. The shortest distance between the fourth gap and the fifth gap is less than the shortest distance between the sixth gap and the seventh gap. The included angle between an extending direction of the fourth gap and the first boundary is greater than 70 degrees.

According to some embodiments, the fifth block is closer to the first boundary than the eighth block. A line from the center of the fifth block to the center of the sixth block forms an included angle of more than 45 degrees with a line from the center of the fifth block to the center of the eighth block.

According to some embodiments, the wireless transmission module further includes a first protection element, a second protection element and a first adhesive assembly. The first protection element is configured to be connected to the induction substrate. The second protection element is configured to be connected to the induction substrate. The first adhesive assembly is configured to firmly adhere the coil assembly to the first protection element.

According to some embodiments, the induction substrate is located between the first protection element and the second protection element. The first protection element and the second protection element have different materials.

According to some embodiments, when viewed along the winding axis, the size of the first protection element is larger than the size of the induction substrate. When viewed along the winding axis, the size of the second protection element is larger than the size of the induction substrate.

According to some embodiments, the first protection element has a first contact portion, a bending portion and a second contact portion. The first contact portion is configured to contact the first surface of the induction substrate. The second contact portion is configured to contact the second protection element. The second protection element is configured to contact a second surface of the induction substrate. The first surface and the second surface are located on opposite sides of the induction substrate.

According to some embodiments, an extending direction of the bending portion is not parallel to an extending direction of the first contact portion. The extending direction of the bending portion is not parallel to an extending direction of the second contact portion. At least a portion of the bending portion is not in contact with a side surface of the induction substrate.

According to some embodiments, the bending portion, the side surface and the second protection element form an interspace. The side surface is connected between the first surface and the second surface.

According to some embodiments, the first adhesive assembly is disposed between the coil assembly and the first protection element. The coil assembly is adhered to the first protection element by the first adhesive assembly. The shape of the first adhesive assembly corresponds to the coil assembly. When viewed along the winding axis, the size of the first adhesive assembly is less than or equal to the size of the coil assembly.

According to some embodiments, the coil assembly is disposed between the first adhesive assembly and the first protection element. The shape of the first adhesive assembly corresponds to the first protection element. When viewed along the winding axis, the size of the first adhesive assembly is equal to the size of the first protection element. The first adhesive assembly is adhered to the coil assembly. The first protection element is adhered to the coil assembly.

According to some embodiments, the first protection element and the first adhesive assembly have different materials. The Young's modulus of the first protection element is different from that of the first adhesive assembly.

The present disclosure provides a wireless transmission module for transmitting energy or signals, including a coil assembly and an induction substrate. The induction substrate is disposed adjacent to the coil assembly. The induction substrate is configured to change the electromagnetic field distribution near the coil assembly so that the electromagnetic waves of the coil assembly are more concentrated. The design of the wireless transmission module of the present disclosure can improve mechanical strength, usage efficiency, charging efficiency, heat dissipation efficiency, and achieve overall miniaturization and overall weight reduction, and reduce electromagnetic interference.

In some embodiments, the induction substrate may be subjected to a pressing process, so that the induction substrate has a plurality of first cracks and second cracks. The first crack and the second crack are interleaved with each other, and the first crack is not parallel to the second crack. Therefore, these first cracks and the second cracks may form a plurality of blocks. The block adjacent to the boundary is the smallest, and the block located at the center of the induction substrate is the largest. Based on such a design, the flexibility of the induction substrate can be effectively increased, thereby avoiding the problem of damage to the induction substrate when it is bent or impacted.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an exploded diagram of a wireless transmission module 100 according to an embodiment of the present disclosure.

FIG. 2 is a top view of the wireless transmission module 100 after being assembled according to an embodiment of the present disclosure.

FIG. 3 is a diagram of the wireless transmission module 100 after being assembled when viewed along the Y-axis according to an embodiment of the present disclosure.

FIG. 4 is an enlarged diagram of an area EX1 in FIG. 3 according to an embodiment of the present disclosure.

FIG. 4A and FIG. 4B are enlarged diagrams of the wireless transmission module 100 according to different embodiments of the present disclosure

FIG. 5 is a schematic top view of the induction substrate 106 according to an embodiment of the present disclosure.

FIG. 6 is an enlarged schematic view of the area EX2 in FIG. 5 according to an embodiment of the present disclosure.

FIG. 7 is an enlarged schematic diagram of the induction substrate 106 according to another embodiment of the present disclosure.

FIG. 8 is an enlarged diagram of the induction substrate 106 according to another embodiment of the present disclosure.

FIG. 8A is an enlarged diagram of the induction substrate 106 according to another embodiment of the present disclosure.

FIG. 9 is an exploded diagram of a wireless transmission module 100A according to another embodiment of the present disclosure.

### DETAILED DESCRIPTION OF THE ILLUSTRATIVE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

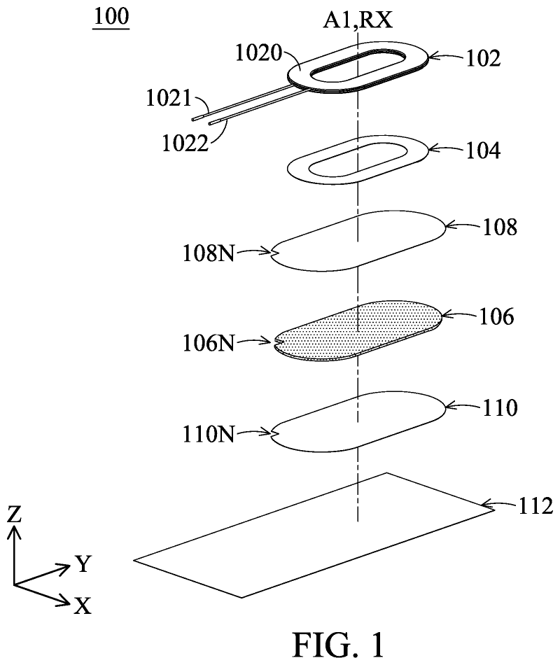

Please refer to FIG. 1, which is an exploded diagram of a wireless transmission module 100 according to an embodiment of the present disclosure. As shown in FIG. 1, the wireless transmission module 100 is a wireless transmission module that can be used to transmit energy or signals. In this embodiment, the wireless transmission module 100 may include a coil assembly 102, a first adhesive assembly 104, an induction substrate 106, a first protection element 108, a second protection element 110 and a third protection element 112.

In this embodiment, the coil assembly 102, the first adhesive assembly 104, the first protection element 108, the induction substrate 106, the second protection element 110 and the third protection element 112 are arranged in sequence in a first direction A1. The first direction A1 may be the extending direction of the winding axis RX of the coil assembly 102.

In this embodiment, the coil assembly 102 can serve as a charging coil to be wireless charged by an external charging device. For example, the coil assembly 102 can operate as a resonant charging coil based on the standard of the Alliance for Wireless Power (A4WP), but it is not limited thereto.

In addition, the coil assembly 102 can operate as an inductive charging coil based on the standard of Wireless Power Consortium (WPC), such as the Qi standard. Therefore, the coil assembly 102 can respond to different forms of charging so as to enlarge the range of applications in this embodiment. For example, in the case of a close distance (for example, 1 cm or less), the inductive type operation is used; and at a long distance, a resonance type operation is used.

In this embodiment, the coil assembly 102 can also be used as a communication coil, for example, operating in Near Field Communication (NFC) mode to communicate with external electronic devices.

In this embodiment, the induction substrate 106 is disposed adjacent to the coil assembly 102, and the induction substrate 106 is configured to change the electromagnetic field distribution near the coil assembly 102. The induction substrate 106 may be a magnetic body, such as a ferrite, but it is not limited thereto. For example, in other embodiments, the induction substrate 106 may also include a nanocrystalline material. The induction substrate 106 may have a magnetic permeability corresponding to the coil assembly 102, so that the electromagnetic waves of the coil assembly 102 can be more concentrated.

The first adhesive assembly 104, the first protection element 108, the second protection element 110, and the third protection element 112 may be double-sided adhesive tape or single-sided adhesive tape to adhere to one or two adjacent elements. In some embodiments, one or more of the first adhesive assembly 104, the first protection element 108 and the second protection element 110 may be made of polyethylene terephthalate (PET), but it is not limited to this. The third protection element 112 can be used to protect the wireless transmission module 100 and is removed when the wireless transmission module 100 is installed in an electronic device (not shown).

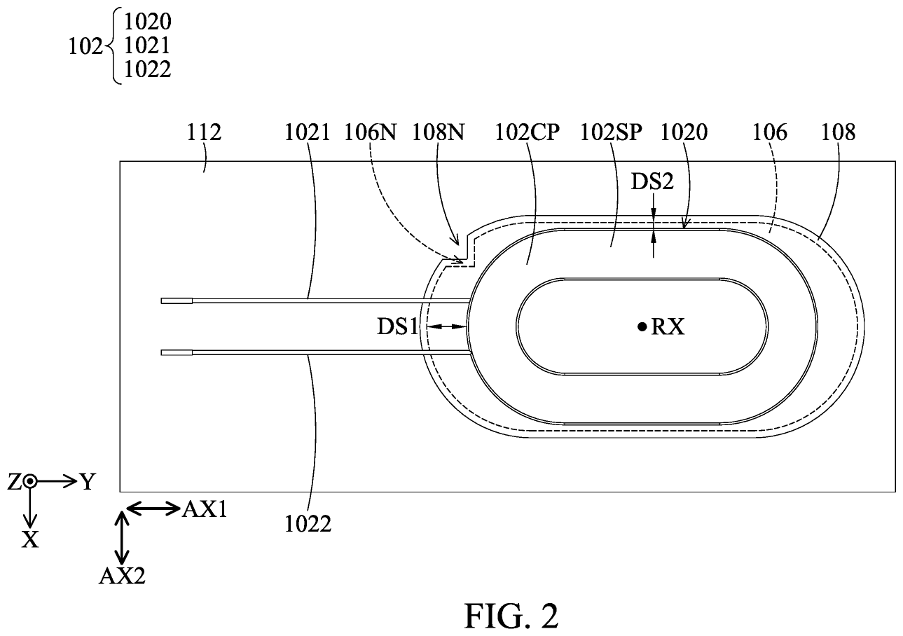

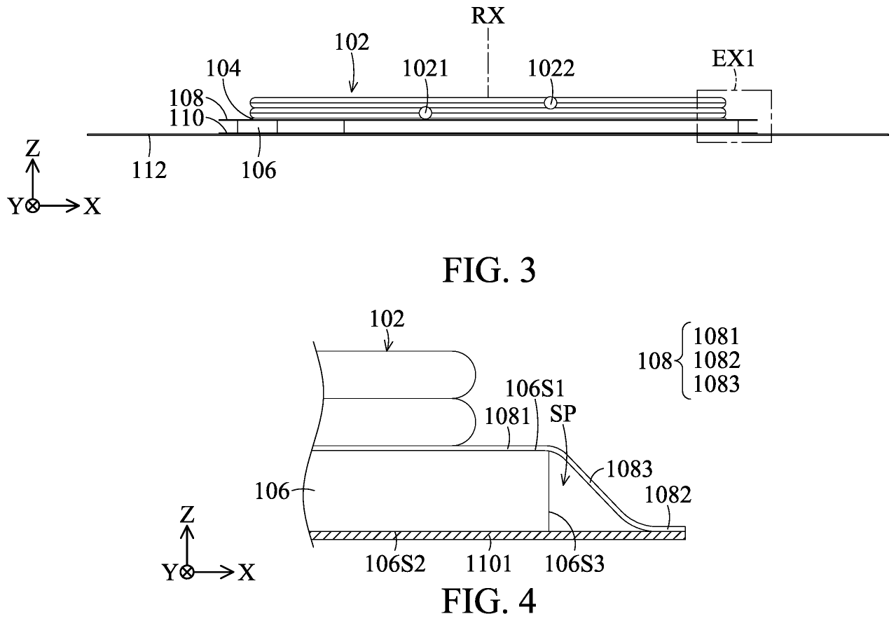

Please refer to FIG. 1 to FIG. 3 together. FIG. 2 is a top view of the wireless transmission module 100 after being assembled according to an embodiment of the present disclosure, and FIG. 3 is a diagram of the wireless transmission module 100 after being assembled when viewed along the Y-axis according to an embodiment of the present disclosure. As shown in FIG. 1 and FIG. 2, the wireless transmission module 100 defines a first axis AX1 and a second axis AX2, and the first axis AX1 is perpendicular to the second axis AX2. For example, the first axis AX1 is parallel to the Y-axis, the second axis AX2 is parallel to the X-axis, and the first axis AX1, the second axis AX2, and the winding axis RX are perpendicular to each other.

In this embodiment, as shown in FIG. 1, the coil assembly 102 has a main body 1020, a first leading wire 1021 and a second leading wire 1022. The first leading wire 1021 and the second leading wire 1022 are connected to the main body 1020, and the first leading wire 1021 is substantially parallel to the second leading wire 1022.

In addition, as shown in FIG. 2, when viewed in the first direction A1 (the direction of the winding axis RX), the main body 1020 has two straight portions 102SP and two bending portions 102CP, these straight portions 102SP are connected to these bending portions 102CP, and the main body 1020 may have an oval structure.

Specifically, as shown in FIG. 2, when viewed in the first direction A1 (the direction of the winding axis RX), there is a distance DS1 between the main body 1020 and the induction substrate 106 along the first axis AX1, there is a second distance DS2 between the main body 1020 and the induction substrate 106 along the second axis AX2, and the first distance DS1 is greater than the second distance DS2.

It should be noted that, as shown in FIG. 2, the first protection element 108 has a first notch 108N, the induction substrate 106 has a second notch 106N, and the second protection element 110 has a third notch 110N. The first notch 108N corresponds to the shape of the second notch 107N, and the third notch 110N also corresponds to the shape of the second notch 107N.

The first notch 108N, the second notch 106N and the third notch 110N can be serve as a positioning structure, so that the wireless transmission module 100 can be positioned accurately. In other embodiments, the first protection element 108, the induction substrate 106 and the second protection element 110 may not have the aforementioned first notch 108N, second notch 106N and third notch 110N.

In this embodiment, the first protection element 108 may be a single-sided tape configured to be connected to the induction substrate 106, and the second protection element 110 may be a double-sided tape configured to be connected to the induction substrate 106. Furthermore, the first adhesive assembly 104 may be a double-sided tape configured to firmly adhere the coil assembly 102 to the first protection element 108.

As shown in FIG. 1 and FIG. 3, the induction substrate 106 is located between the first protection element 108 and the second protection element 110, and the first protection element 108 and the second protection element 110 can cooperatively cover the induction substrate 106. Furthermore, the first protection element 108 and the second protection element 110 may have different materials. For example, the first protection element 108 may be made of polyethylene terephthalate (PET), and the second protection element 110 may be made of polyvinyl chloride (PVC).

Because the first protection element 108 and the second protection element 110 are made of different materials, the Young's modulus of the two are different. Based on such a design, when the wireless transmission module 100 is impacted, because one of the first protection element 108 and the second protection element 110 is hard and the other is soft, the impact force can be effectively absorbed, thereby protecting the induction substrate 106 from being damaged.

As shown in FIG. 2, when viewed along the winding axis RX, the size of the first protection element 108 is larger than the size of the induction substrate 106. When viewed along the winding axis RX, the size of the second protection element 110 is larger than the size of the induction substrate 106. In this embodiment, the first protection element 108 and the second protection element 110 may have the same size, but it is not limited thereto.

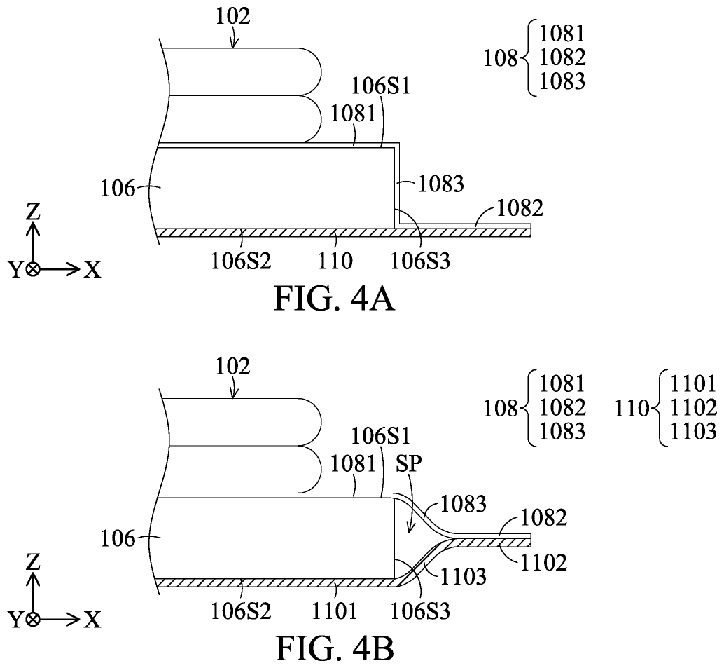

Please refer to FIG. 3 and FIG. 4. FIG. 4 is an enlarged diagram of an area EX1 in FIG. 3 according to an embodiment of the present disclosure. As shown in FIG. 4, the first protection element 108 has a first contact portion 1081, a bending portion 1083 and a second contact portion 1082, and the induction substrate 106 has a first surface 106S1. The first contact portion 1081 is configured to be in contact with the first surface 106S1 of the induction substrate 106.

The second contact portion 1082 is configured to be in contact with the second protection element 110, and the second protection element 110 is configured to be in contact with a second surface 106S2 of the induction substrate 106. The first surface 106S1 and the second surface 106S2 are located on opposite sides of the induction substrate 106, and the first surface 106S1 faces the coil assembly 102.

As shown in FIG. 4, the extending direction of the bending portion 1083 is not parallel to the extending direction of the first contact portion 1081, and the extending direction of the bending portion 1083 is not parallel to the extending direction of the second contact portion 1082.

It should be noted that at least a portion of the bending portion 1083 is not in contact with a side surface 106S3 of the induction substrate 106. Therefore, the bending portion 1083, the side surface 106S3 and the second protection element 110 form an interspace SP. The side surface 106S3 is connected between the first surface 106S1 and the second surface 106S2.

In addition, it should be noted that the interspace SP is enclosed between the first protection element 108, the second protection element 110 and the induction substrate 106, so it can ensure that the particles generated by the induction substrate 106 will not fall to the outside.

Similarly, as shown in FIG. 2 and FIG. 3, in this embodiment, because the sizes of the first protection element 108 and the second protection element 110 are larger than the size of the induction substrate 106, the portion of the first protection element 108 close to the first notch 108N can be indeed attached to the portion of the second protection element 110 close to the third notch 110N, so as to completely close the second notch 106N, so it can ensure that the particles generated by the induction substrate 106 will not fall to the outside.

Please refer to FIG. 4A and FIG. 4B. FIG. 4A and FIG. 4B are enlarged diagrams of the wireless transmission module 100 according to different embodiments of the present disclosure. In the embodiment shown in FIG. 4A, the extending direction of the bending portion 1083 is perpendicular to the extending direction of the first contact portion 1081 and the second contact portion 1082, and the bending portion 1083 is tightly in contact with the side surface 106S3. Based on such a configuration, there is no interspace between the bending portion 1083 and the side surface 106S3, so it can ensure that the particles generated by the induction substrate 106 will not fall to the outside.

In the embodiment of FIG. 4B, similar to the first protection element 108, the second protection element 110 may also have a third contact portion 1101, a bending portion 1103, and a fourth contact portion 1102. As shown in FIG. 4B, the third contact portion 1101 is configured to be in contact with the second surface 106S2, the extending direction of the bending portion 1103 is not parallel to the extending direction of the third contact portion 1101, and the extending direction of the bending portion 1103 is not parallel to the extending direction of the fourth contact portion 1102, either.

Similarly, at least a portion of the bending portion 1103 is not in contact with the side surface 106S3, the fourth contact portion 1102 is bonded to the second contact portion 1082, and the bonding position in the Z-axis is located between the first contact portion 1081 and the third contact portion 1101. Therefore, the bending portion 1083, the bending portion 1103 and the side surface 106S3 formed with the interspace SP. Based on such a structural configuration, it can not only ensure that the particles generated by the induction substrate 106 will not fall to the outside, but also can increase the connection strength between the first protection element 108 and the second protection element 110.

Please go back to FIG. 1 and FIG. 3 again. In this embodiment, the first adhesive assembly 104 is disposed between the coil assembly 102 and the first protection element 108. The first adhesive assembly 104 can be a double-sided tape, and the coil assembly 102 is adhered to the first protection element 108 by the first adhesive assembly 104.

The shape of the first adhesive assembly 104 corresponds to the shape of the coil assembly 102, such as an oval ring. As shown in FIG. 3, when viewed along the winding axis RX, the size of the first adhesive assembly 104 is smaller than or equal to the size of the coil assembly. Based on such a design, it can prevent dust from adhering to the first adhesive assembly 104, thereby affecting the efficiency of the wireless transmission module 100.

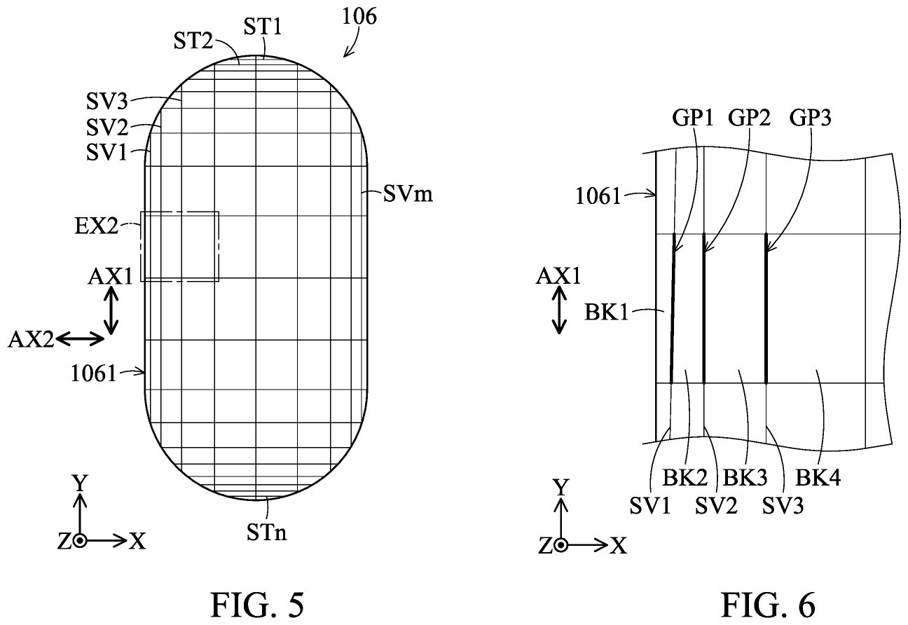

Next, please refer to FIG. 5, which is a schematic top view of the induction substrate 106 according to an embodiment of the present disclosure. In this embodiment, the induction substrate 106 may be subjected to a pressing process, so that when viewed along the winding axis RX (the Z-axis), the induction substrate 106 has a plurality of first cracks SV1˜SVm and second cracks ST1˜STn, where m and n are natural numbers. The first cracks and the second cracks are interleaved with each other, and the first crack is not parallel to the second crack.

Therefore, the first cracks and the second cracks may form a plurality of blocks. Please refer to FIG. 6, which is an enlarged schematic view of the area EX2 in FIG. 5 according to an embodiment of the present disclosure. As shown in FIG. 6, the induction substrate 106 may include a first block BK1, a second block BK2, a third block BK3 and a fourth block BK4.

The second block BK2 is adjacent to the first block BK1, the third block BK3 is adjacent to the second block BK2, and the fourth block BK4 is adjacent to the third block BK3. Furthermore, the induction substrate 106 may have a first gap GP1, a second gap GP2 and a third gap GP3.

The first gap GP1 is a part of the first crack SV1, the second gap GP2 is a part of the first crack SV2, and the third gap GP3 is a part of the third crack SV3. The first gap GP1 is adjacent to and located between the first block BK1 and the second block BK2, the second gap GP2 is adjacent to and located between the second block BK2 and the third block BK3, and the third gap GP3 is adjacent to and located between the third block BK3 and the fourth block BK4.

The second block BK2 is located between the first gap GP1 and the second gap GP2, and the third block BK3 is located between the second gap GP2 and the third gap GP3. It should be noted that the shortest distance between the first gap GP1 and the second gap GP2 is less than the shortest distance between the second gap GP2 and the third gap GP3. That is, the size of the block closer to the center of the induction substrate 106 will be larger.

In this embodiment, the first crack SV1 may not be parallel to the first crack SV2, so that the extending direction of the first gap GP1 is not parallel to the extending direction of the second gap GP2. For example, the included angle between the extending direction of the first gap GP1 and the extending direction of the second gap GP2 may be less than 20 degrees, and the included angle between the extending direction of the second gap GP2 and the extending direction of the third gap GP3 may be less than 20 degrees.

Similarly, the first crack SV2 may not be parallel to the first crack SV3, and so on. Similarly, the second crack ST1 may not be parallel to the second crack ST2. For example, the included angle between the second crack ST1 and the second crack ST2 may be less than 20 degrees, and so on for the rest of the second cracks.

Furthermore, the induction substrate 106 further includes a first boundary 1061 extending along the first axis AX1. As shown in FIG. 6, the first gap GP1 is closer to the first boundary 1061 than the second gap GP2, and the second gap GP2 is closer to the first boundary 1062 than the third gap GP3. Similarly, the included angle between the extending direction of the first gap GP1 and the extending direction of the first boundary 1061 may be less than 20 degrees.

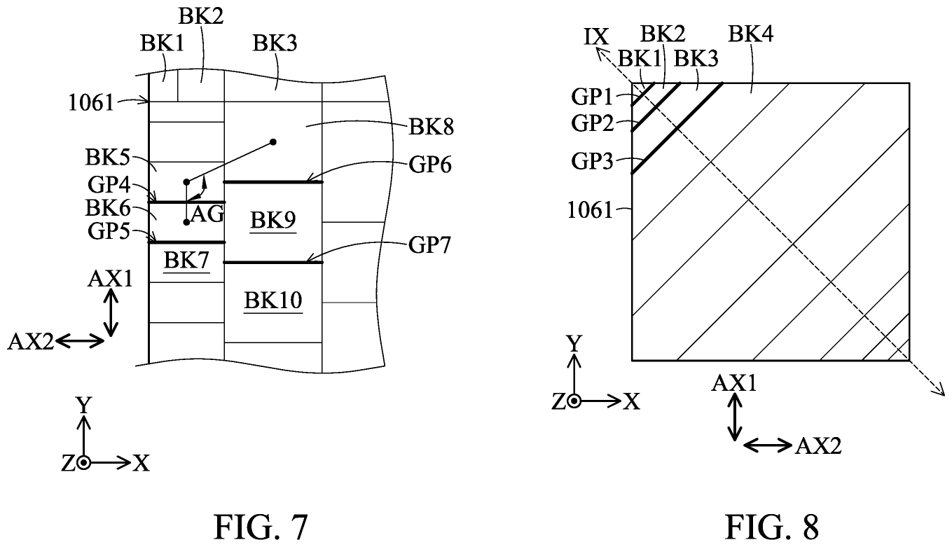

Please refer to FIG. 7, which is an enlarged schematic diagram of the induction substrate 106 according to another embodiment of the present disclosure. In this embodiment, in addition to the aforementioned first block BK1, second block BK2 and third block BK3, the induction substrate 106 may further include a fifth block BK5, a sixth block BK6, a seventh block BK7, an eighth block BK8, a ninth block BK9, and a tenth block BK10.

The sixth block BK6 is adjacent to the fifth block BK5, and the seventh block BK7 is adjacent to the sixth block BK6. Furthermore, the ninth block BK9 is adjacent to the eighth block BK8, and the tenth block BK10 is adjacent to the ninth block BK9.

Similarly, the induction substrate 106 includes a fourth gap GP4, a fifth gap GP5, a sixth gap GP6, and a seventh gap GP7. The fourth gap GP4 is adjacent to and located between the fifth block BK5 and the sixth block BK6.

The fifth gap GP5 is adjacent to and located between the sixth block BK6 and the seventh block BK7, the sixth gap GP6 is adjacent to and located between the eighth block BK8 and the ninth block BK9, and the seventh gap GP7 is adjacent to and located between the ninth block BK9 and the tenth block BK10.

The sixth block BK6 is located between the fourth gap GP4 and the fifth gap GP5, and the ninth block BK9 is located between the sixth gap GP6 and the seventh gap GP7. The shortest distance between the fourth gap GP4 and the fifth gap GP5 is less than the shortest distance between the sixth gap GP6 and the seventh gap GP7. That is, the size of the sixth block BK6 is smaller than the size of the ninth block BK9. Similarly, the size of the seventh block BK7 is smaller than the size of the tenth block BK10, and so on.

In this embodiment, the fourth gap GP4 may not be parallel to the second axis AX2. For example, the included angle between the extending direction of the fourth gap GP4 and the first boundary 1061 is greater than 70 degrees. In this embodiment, the fourth gap GP4 is perpendicular to the first boundary 1061, but it is not limited thereto. Furthermore, the fifth block BK5 is closer to the first boundary 1061 than the eighth block BK8.

It should be noted that the line from the center of the fifth block BK5 to the center of the sixth block BK6 forms an included angle AG with the line from the center of the fifth block BK5 to the center of the eighth block BK8, and the included angle AG is greater than degrees.

In addition, as shown in FIG. 7, in this embodiment, the fourth gap GP4 is not directly connected to the sixth gap GP6, and the fourth gap GP4 may not be parallel to the sixth gap GP6. Similarly, the fifth gap GP5 is not directly connected to the seventh gap GP7, and the fifth gap GP5 may not be parallel to the seventh gap GP7. Furthermore, the fourth gap GP4 may not be parallel to the fifth gap GP5, and the sixth gap GP6 may not be parallel to the seventh gap GP7.

For example, the included angle between the extending direction of the fourth gap GP4 and the extending direction of the fifth gap GP5 may be less than 20 degrees, the included angle between the extending direction of the fourth gap GP4 and the extending direction of the sixth gap GP6 may be less than 20 degrees, the included angle between the extending direction of the sixth gap GP6 and the extending direction of the seventh gap GP7 may be less than 20 degrees, and the included angle between the extending direction of the fifth gap GP5 and the extending direction of the seventh gap GP7 may be less than 20 degrees.

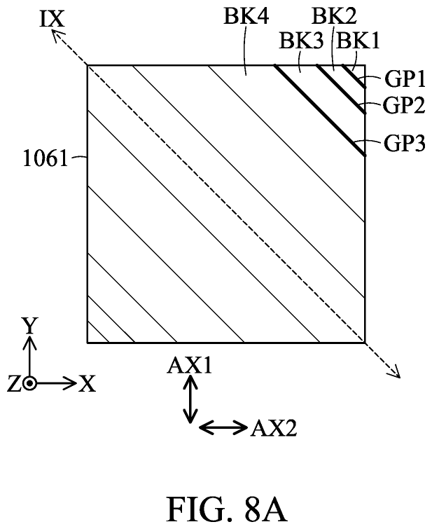

Next, please refer to FIG. 8, which is an enlarged diagram of the induction substrate 106 according to another embodiment of the present disclosure. In this embodiment, the first block BK1, the second block BK2, the third block BK3 and the fourth block BK4 are sequentially arranged along an inclined axis IX. The inclined axis IX is not parallel to the first axis AX1 and the second axis AX2. For example, the included angle between the inclined axis IX and the first axis AX1 may be 45 degrees, but it is not limited thereto.

As shown in FIG. 8, the length of the first gap GP1 is different from the length of the second gap GP2. For example, the length of the first gap GP1 is less than the length of the second gap GP2. Similarly, the length of the second gap GP2 is different from the length of the third gap GP3. For example, the length of the second gap GP2 is less than the length of the third gap GP3.

Furthermore, the included angle between the extending direction of the first gap GP1 and the extending direction of the first boundary 1061 may be greater than 45 degrees, and the extending direction of the first gap GP1 may not be parallel to the extending direction of the second gap GP2. For example, the included angle between the extending direction of the first gap GP1 and the extending direction of the second gap GP2 is less than 20 degrees. Similarly, the included angle between the extending direction of the second gap GP2 and the extending direction of the third gap GP3 is less than 20 degrees, and so on.

In this embodiment, the included angle between the inclined axis IX and the extending direction of the first gap GP1 may be, for example, 70 to 90 degrees, the included angle between inclined axis IX and the extending direction of the second gap GP2 may be, for example, 70 to 90 degrees, and the included angle between the inclined axis IX and the extending direction of the third gap GP3 may be, for example, 70 to 90 degrees, but they are not limited thereto.

Next, please refer to FIG. 8A, which is an enlarged diagram of the induction substrate 106 according to another embodiment of the present disclosure. In other embodiments, as shown in FIG. 8A, the included angle between the inclined axis IX and the extending direction of the first gap GP1 may be, for example, 0-20 degrees, the included angle between the inclined axis IX and the extending direction of the second gap GP2 may be, for example, 0-20 degrees, and the included angle of the inclined axis IX and the extending direction of the third gap GP3 may be, for example, 0-20 degrees.

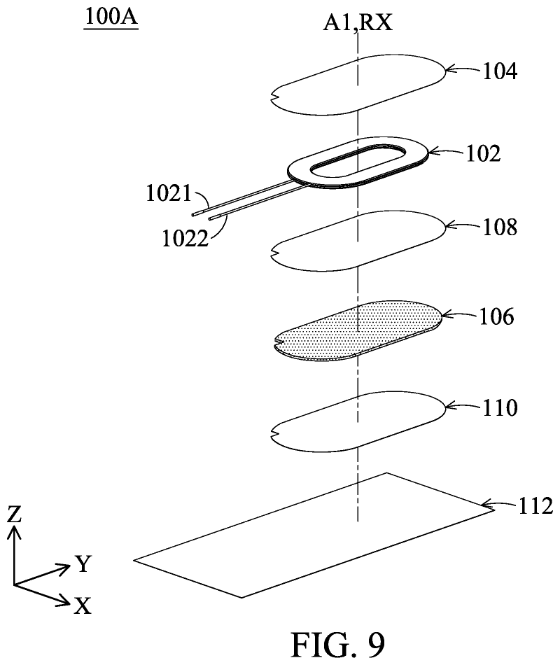

Please refer to FIG. 9, which is an exploded diagram of a wireless transmission module 100A according to another embodiment of the present disclosure. In this embodiment, the coil assembly 102 is disposed between the first adhesive assembly 104 and the first protection element 108, and the shape of the first adhesive assembly 104 corresponds to the first protection element 108.

When viewed along the winding axis RX, the size of the first adhesive assembly 104 is equal to the size of the first protection element 108. The first adhesive assembly 104 is adhered to the coil assembly 102, and the first protection element 108 is adhered to the coil assembly 102. That is, the coil assembly 102 is covered by the first adhesive assembly 104 and the first protection element 108.

In this embodiment, the first adhesive assembly 104 may be a single-sided tape or a double-sided tape, the first protection element 108 may be a double-sided tape, and the first protection element 108 and the first adhesive assembly 104 have different materials. Therefore, the Young's modulus of the first protection element 108 and that of the first adhesive assembly 104 are different.

Based on such a design, when the wireless transmission module 100A is impacted, because one of the first protection element 108 and the first adhesive assembly 104 is hard and the other is soft, the impact force can be effectively absorbed, thereby protecting the induction substrate 106 and the coil assembly 102 from being damaged.

In conclusion, the present disclosure provides a wireless transmission module for transmitting energy or signals, including a coil assembly and an induction substrate. The induction substrate is disposed adjacent to the coil assembly. The induction substrate is configured to change the electromagnetic field distribution near the coil assembly so that the electromagnetic waves of the coil assembly are more concentrated. The design of the wireless transmission module of the present disclosure can improve mechanical strength, usage efficiency, charging efficiency, heat dissipation efficiency, and achieve overall miniaturization and overall weight reduction, and reduce electromagnetic interference.

In some embodiments, the induction substrate 106 may be subjected to a pressing process, so that the induction substrate 106 has a plurality of first cracks and second cracks. The first crack and the second crack are interleaved with each other, and the first crack is not parallel to the second crack. Therefore, these first cracks and the second cracks may form a plurality of blocks. The block adjacent to the boundary is the smallest, and the block located at the center of the induction substrate 106 is the largest. Based on such a design, the flexibility of the induction substrate 106 can be effectively increased, thereby avoiding the problem of damage to the induction substrate 106 when it is bent or impacted.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A wireless transmission module for transmitting energy or signals, comprising:
a coil assembly, having a winding axis; and
an induction substrate, corresponding to the coil assembly;
wherein the induction substrate has a first surface facing the coil assembly.

2. The wireless transmission module as claimed in claim 1, wherein
the induction substrate includes:
a first block;
a second block, adjacent to the first block;
a third block, adjacent to the second block;
a fourth block, adjacent to the third block;
a first gap, adjacent to and between the first block and the second block;
a second gap, adjacent to and between the second block and the third block; and
a third gap, adjacent to and between the third block and the fourth block.

3. The wireless transmission module as claimed in claim 2, wherein
the second block is located between the first gap and the second gap;
the third block is located between the second gap and the third gap;
a shortest distance between the first gap and the second gap is less than a shortest distance between the second gap and the third gap.

4. The wireless transmission module as claimed in claim 3, wherein
an included angle between an extending direction of the first gap and an extending direction of the second gap is less than 20 degrees;
an included angle between the extending direction of the second gap and an extending direction of the third gap is less than 20 degrees.

5. The wireless transmission module as claimed in claim 4, wherein
the induction substrate further includes:
a first boundary, extending along a first axis;
the first block, the second block, the third block and the fourth block are sequentially arranged along an inclined axis;
the inclined axis is not parallel to the first axis.

6. The wireless transmission module as claimed in claim 5, wherein
a length of the first gap is different from a length of the second gap;
the length of the first gap is less than the length of the second gap.

7. The wireless transmission module as claimed in claim 6, wherein
the length of the second gap is different from a length of the third gap;
the length of the second gap is less than the length of the third gap;
an included angle between the extending direction of the first gap and an extending direction of the first boundary is greater than 45 degrees.

8. The wireless transmission module as claimed in claim 4, wherein
the induction substrate further includes:
a first boundary, extending along a first axis;
the first gap is closer to the first boundary than the second gap;
the second gap is closer to the first boundary than the third gap;
an included angle between the extending direction of the first gap and an extending direction of the first boundary is less than 20 degrees.

9. The wireless transmission module as claimed in claim 8, wherein
the induction substrate further includes:
a fifth block;
a sixth block, adjacent to the fifth block;
a seventh block, adjacent to the sixth block;
an eighth block;
a ninth block, adjacent to the eighth block;
a tenth block, adjacent to the ninth block;
a fourth gap, adjacent to and between the fifth block and the sixth block;
a fifth gap, adjacent to and between the sixth block and the seventh block;
a sixth gap, adjacent to and between the eighth block and the ninth block; and
a seventh gap, adjacent to and between the ninth block and the tenth block.

10. The wireless transmission module as claimed in claim 9, wherein
the sixth block is located between the fourth gap and the fifth gap;
the ninth block is located between the sixth gap and the seventh gap;
a shortest distance between the fourth gap and the fifth gap is less than a shortest distance between the sixth gap and the seventh gap;
an included angle between an extending direction of the fourth gap and the first boundary is greater than 70 degrees.

11. The wireless transmission module as claimed in claim 9, wherein
the fifth block is closer to the first boundary than the eighth block;
a line from a center of the fifth block to a center of the sixth block forms an included angle of more than 45 degrees with a line from the center of the fifth block to a center of the eighth block.

12. The wireless transmission module as claimed in claim 1, wherein
the wireless transmission module further includes:
a first protection element, configured to be connected to the induction substrate;
a second protection element, configured to be connected to the induction substrate; and
a first adhesive assembly, configured to firmly adhere the coil assembly to the first protection element.

13. The wireless transmission module as claimed in claim 12, wherein
the induction substrate is located between the first protection element and the second protection element;
the first protection element and the second protection element have different materials.

14. The wireless transmission module as claimed in claim 13, wherein
when viewed along the winding axis, a size of the first protection element is larger than a size of the induction substrate;
when viewed along the winding axis, a size of the second protection element is larger than the size of the induction substrate.

15. The wireless transmission module as claimed in claim 14, wherein
the first protection element has a first contact portion, a bending portion and a second contact portion;
the first contact portion is configured to contact the first surface of the induction substrate;
the second contact portion is configured to contact the second protection element;
the second protection element is configured to contact a second surface of the induction substrate;
the first surface and the second surface are located on opposite sides of the induction substrate.

16. The wireless transmission module as claimed in claim 15, wherein
an extending direction of the bending portion is not parallel to an extending direction of the first contact portion;
the extending direction of the bending portion is not parallel to an extending direction of the second contact portion;
at least a portion of the bending portion is not in contact with a side surface of the induction substrate.

17. The wireless transmission module as claimed in claim 16, wherein
the bending portion, the side surface and the second protection element form an interspace;
the side surface is connected between the first surface and the second surface.

18. The wireless transmission module as claimed in claim 12, wherein
the first adhesive assembly is disposed between the coil assembly and the first protection element;
the coil assembly is adhered to the first protection element by the first adhesive assembly;
a shape of the first adhesive assembly corresponds to the coil assembly;
when viewed along the winding axis, a size of the first adhesive assembly is less than or equal to a size of the coil assembly.

19. The wireless transmission module as claimed in claim 12, wherein
the coil assembly is disposed between the first adhesive assembly and the first protection element;
a shape of the first adhesive assembly corresponds to the first protection element;
when viewed along the winding axis, a size of the first adhesive assembly is equal to a size of the first protection element;
the first adhesive assembly is adhered to the coil assembly;
the first protection element is adhered to the coil assembly.

20. The wireless transmission module as claimed in claim 19, wherein
the first protection element and the first adhesive assembly have different materials;
the Young's modulus of the first protection element is different from that of the first adhesive assembly.
